(19) United States
(12) Patent Application Publication
(10) Pub. No.: US 2009/0289786 A1
(43) Pub. Date: Nov. 26, 2009

(54) Sensor arrangement for securing the loads of containers

(76) Inventor: Rainer Koch, Fuchshain (DE)

Correspondence Address: MILDE & HOFFBERG, LLP, 10 BANK STREET, SUITE 460, WHITE PLAINS, NY, 10606, US

(21) Appl. No.: 12/309,004

(22) PCT Filed: Jul. 4, 2007
(86) PCT No.: PCT/DE2007/001178

§ 371 Date: Mar. 2, 2009

(30) Foreign Application Priority Data
Jul. 4, 2006 (DE) 10 2006 030 681.3

(51) Int. Cl. G08B 1/08

(52) U.S. Cl. 340/539.26; 340/539.1; 340/547; 340/545.3

(57) ABSTRACT

A sensor arrangement for securing the contents of a container (1) comprises a housing part (18); a magnetic device (6, 7) for attaching the housing part (18) to a first door (11) of the container; a sensor (5) for monitoring the interior of the container; a first switch (30) which can be actuated when the housing part (18), including the magnetic device (6, 7), is attached to the first door (11); and a second switch (24) which is actuated when a second door (12) of the container, which is disposed next to the first door (11), is closed. The sensor arrangement further comprises a microprocessor (25) for evaluating the alarm signals of the sensor (5); a power supply (35) and a transmitter (26). The first switch (30) can be actuated when the housing part (18) is attached to the first door (11) in order to switch on the power supply for activating the sensor arrangement (1). The second switch (24) is actuated when the second door (12) is closed in order to activate the sensor (5) for monitoring the interior. The microprocessor (25) processes alarm signals, which are generated by the sensor (5) indicating authorized entry into the interior, and transmits them to the transmitter (26) which, in turn, transmits them to a further transmitter (27) provided on the outside of the container for transmission to an intervention center.

The present invention relates to a sensor arrangement for securing the interior of a receptacle, in particular a container, in particular a rented or leased container on the transport route in intermodal transport according to patent claim 1.

In connection with securing containers, it is important to determine if manipulation of the transported goods and/or the removal of transported goods by unauthorized opening of the container through breaking open the doors of the container or by damaging the outer skin of the container occur during the containers transport. It is also important to determine if foreign objects, e.g., explosives or drugs, are introduced into the container during its transport. In any case of an undesired manipulation, an alarm signal is to be transmitted to an intervention center.

It is the objective of the present invention to provide a sensor arrangement that can be installed easily in a receptacle, in particular a container, that works autonomously and can be used to determine if unauthorized persons force their way into the interior of the container during its transport.

This objective is achieved by a sensor arrangement with the features of Patent Claim 1. The significant advantage of the present invention is that the present, autonomously operating sensor arrangement can determine whether or not non-authorized persons are forcing or have forced their way into the interior of the container during the transport of a container equipped with the sensor arrangement. Advantageously, the load in particular of rented and leased containers can be secured in this manner on the transport route even in intermodal transport. The introduction of foreign objects into the container can be determined as well. In the case of unauthorized access to the interior of the container, an alarm signal is generated advantageously and transferred in real time to an intervention center, for example as an SMS via a GSM network. If a GSM network is not available at the time the alarm is generated, alarm signals are stored in a memory of the sensor arrangement and then transmitted when the GSM network becomes available.

According to one advantage of the invention, the present sensor arrangement can be attached to the container very easily by magnetic means without the need for tools such that expensive and cumbersome assembly and disassembly can be avoided. Damage to the container is avoided. After the use on one container is finished, the sensor arrangement can be installed right away in another container.

Since the data concerning the unauthorized manipulation is also stored in the sensor arrangement itself, they can be exported immediately at the destination location of the container using a scanner or the like, such that necessary measures can be initiated. For example, in the respective customs zones in the United States, containers are cleared and released for continued transport only if it can be verified that no unauthorized access has occurred during the preceding transport. In case of unauthorized access, the container is sent back to the sender by the customs authorities.

One advantage of a preferred embodiment of the sensor arrangement according to the invention is that it has at least one additional sensor that checks data continuously. When pre-specified target values are exceeded, alarm signals are transmitted in real time to the intervention center, e.g., via the GSM network. Temperature and humidity levels are monitored in this manner, for example. This aids in determining and documenting if transported goods have been damaged or not.

Advantageous embodiments of the invention become apparent from the dependent claims.

Following, the invention and its embodiments are described in greater detail using the figures, of which:

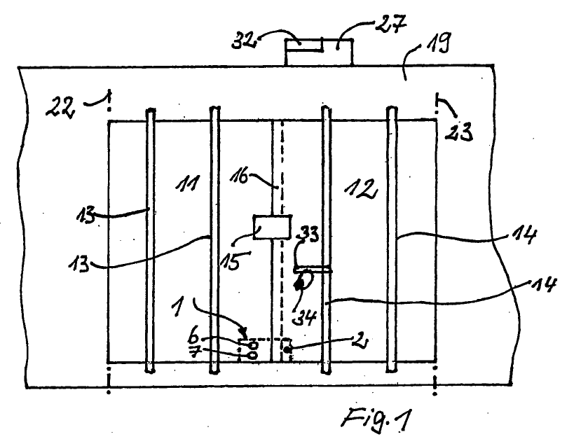

FIG. 1 is a schematic presentation of doors of a container located at one wall of a container and of a sensor arrangement attached on said door for explaining the principle of the present invention.

FIG. 2 shows in part a section of the structure of the sensor arrangement according to the invention.

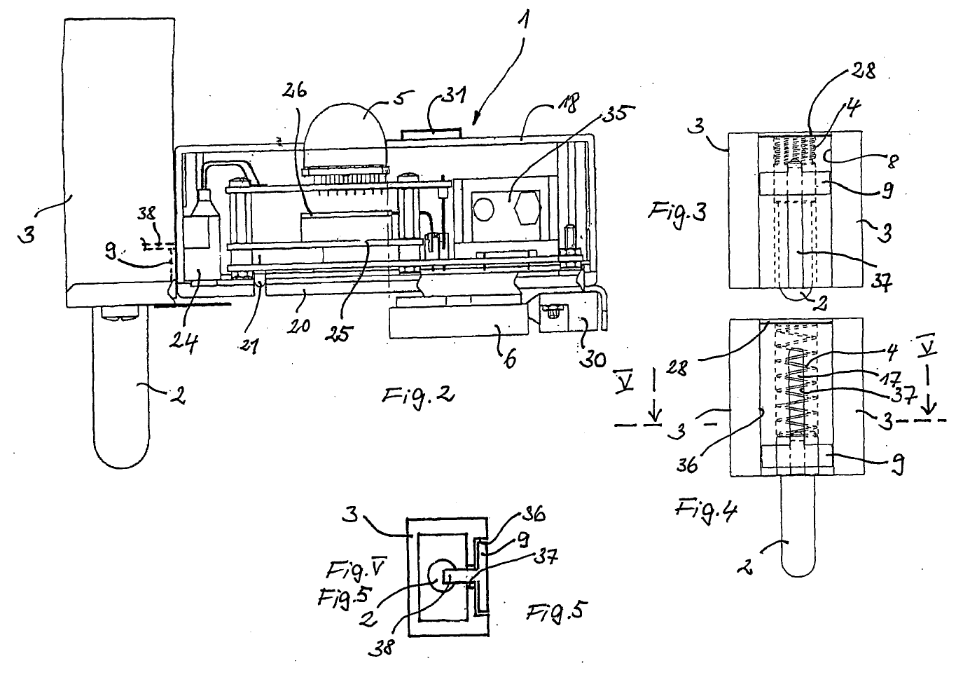

FIGS. 3 to 5 show details for explaining the function of the plunger of the sensor arrangement according to the invention.

The following considerations led to the invention. The load of a container, for example of a rented or leased container can be secured on the transport route in national or intermodal transport by monitoring the interior of the container to register access of unauthorized persons. On the one hand, this allows for the determining if the container load is manipulated in an unauthorized manner. On the other hand, it can also be monitored if foreign objects have been introduced into the interior of the container. A sensor arrangement used for monitoring the interior space can be easily and quickly attached magnetically on the edge of, for example, the left door of the container even by non-skilled laborers and can be activated automatically with regard to its power supply. Only when the closing of the right door of the container is recognized by the sensor arrangement, a sensor serving the interior space monitoring is switched on. The data obtained by the sensor, in case of unauthorized access to the container interior, are transmitted automatically in real time to an intervention center and are stored in a memory of the sensor arrangement. These data are then available both at the intervention center and in the sensor arrangement for evaluation at the intervention center or on site at the destination location of the container. Suitable measures can be initiated both during transport and at the destination location.

According to FIG. 1, the container comprises two doors, namely a left door 11 and a right door 12, that are located in a wall 19 of the container. Doors 11, 12 can pivot around a schematically shown rotating axis 22 or 23, whereby usually the left door 11 is closed first and locked, in an essentially known manner, using a locking bar 13, shown only schematically as well, by rotating said bar around its longitudinal axis. Then the right door 12 is closed such that a sealing lip 16 seals the remaining gap between the left door 11 and the right door 12. Both doors 11, 12 are then in one plane. Locking of the right door 12 is done in this condition in an essentially known manner using additional locking bars 14, which are shown only schematically in FIG. 1 as well and are rotated around their longitudinal axis for locking. The locking bars 13, 14 usually feature actuating bars 33 as shown in FIG. 1 using the example of the left locking bar 14. After locking the container doors 11, 12 a actuating bar 33 is attached at the door 12 with a customs seal 34 in order to avoid or indicate an unauthorized opening.

Typically, a so-called customs plate 15 is attached to the right door 12 and in the closed state protrudes beyond the right door 12 in the direction of the left door 11 and overlapping the same. In order to open the container doors 11, 12 by an authorized person, the customs seal 34 that is located at the locking bar 14 of the right door 12 must be destroyed to be able to open the right door 12. Only then is it possible to open the left door 11. However, the left door 11 can be opened by force by unauthorized persons if the customs plate is bent by unauthorized manipulation using a suitable tool such that the left door 11 becomes accessible by unlocking the locking devices 13.

The present sensor arrangement 1 is arranged at the left door 11 and the right door 12 using a magnetic device 6, 7 such that in the closed state of the doors 11, 12 it overlaps both the left door 11 as well as the right door in the manner shown in FIG. 1.

More precisely, the magnet device comprises at least one, and preferably two magnetic elements 6, 7, which are located at an outer wall 20 of the housing of the sensor arrangement 1. Preferably, the two magnetic elements 6, 7 are attached to the outer wall 20 such that in the assembled state of the sensor arrangement 1, they are located vertically above each other, i.e., are oriented parallel to the rotating axis 22.

The magnetic elements 6 and 7 are attached to the inner side of the left door 11 such that a right partial area of the sensor arrangement 1 protrudes beyond the left door 11 or beyond the sealing lip 16, respectively, towards the right door 12. In this partial area, the sensor arrangement 1 features a plunger 2 for actuating a switch 24 (FIG. 1). The plunger 2 protrudes beyond the plane of the outer wall 20 of the housing part 18. It is pre-stressed toward the outside of the container by the force of an energy store, preferably a compression spring 4. This means that the plunger 2 is pushed or actuated toward the interior against the force of the compression spring when the right door 12 is closed in order to actuate the switch 24. An additional switch 30 is provided that is actuated automatically when the housing of the sensor arrangement 1 is attached to the left door 11.

In addition, the sensor arrangement 1 comprises a sensor 5 for monitoring the interior of the container, with said sensor 5 being preferably an infrared sensor whose function shall be explained in detail below, a power supply 35 for the electronic circuits and components, a microprocessor 25, a transmitter 26, preferably in the form of a short distance radio transmitter, as well as possibly additional sensors 31, for example for the temperature and humidity in the interior of the container.

The present sensor arrangement 1 is placed at the container doors 11, 12 in the following manner with the functional steps being explained below taking place.

1. The sensor arrangement 1 is attached on the inner side to the edge area of the left door 11 pointing towards the right door 12 using the magnetic elements 6, 7 as shown in FIG. 1, such that the partial area protrudes with the plunger 2 beyond the sealing lip 16. At the moment at which the attachment with the magnetic elements 6, 7 takes place, the switch 30, which preferably is a magnetic switch, is actuated. In the process, switch 30 switches on the power supply 35 and the entire electronics is activated. This is indicated, for example, by an indicator light 21, which is preferably in the form of an LED element.

2. Only upon the subsequent closing of the right door 12, the plunger 2 for actuating the switch 24 is pressed inward activating the infrared sensor. This means that in the closed state of both doors 11, 12, the infrared sensor 5 monitors the interior of the container. If, for example, an unauthorized person forcefully accesses the interior of the container, this will be recognized by the infrared sensor 5 as a movement of a heat source. This generates an alarm signal.

If the right door 12 is opened during transport, this is recognized by the actuation of the switch 24 through the movement of the plunger 2 by the compression spring 4. This also generates an alarm signal.

If the left door 11 is opened in an unauthorized manner by destroying the customs plate 15 with the right door closed, the sensor arrangement 1 is separated from the interior of the left door 11 against the magnetic force of the magnetic elements 6, 7. The actuation of the switch 24 through the movement of the plunger 2 by the compression spring 4 is recognized and an alarm signal is generated. The power-down of the power supply 35 that occurs because of the simultaneous actuation of switch 30 is delayed by a sufficient time to transfer an alarm signal to the intervention center indicating the unauthorized opening of the container door 11.

3. An alarm signal generated by the infrared sensor 5 and/or the switch 24 and/or a sensor 31 is processed by the microprocessor 25 and transferred to the transmitter 26 as a signal.

4. The transmitter 26 transmits the signal to a transmitter/receiver 27 (FIG. 1), preferably with a GPS receiver that is located on the outside of the container and that receives via a GPS antenna the respective geographic positions of the container as well as the respective date and time as an information signal. The transmitter/receiver 27 preferably also includes a transmitting unit 32, preferably a quad band GSM module with a GSM antenna for transmitting the signals together with the associated information signals to the intervention center.

FIGS. 3 and 4 show a preferred embodiment of the plunger 2 for actuating the switch 24. The plunger 2 runs through a passage 8 of a housing part 3, which can be designed in one piece together with the housing part 18 or can be placed on it. Affixed axially to the plunger 2 is a disc 9 made of a magnetically conducting material and supported together with the plunger 2 in a movable manner such that it can be moved in and out of the area of a magnetic switch 24 (FIG. 1) for actuating the same. As apparent from FIGS. 3 to 5, the disc 9 can be moved in an opening 36 of the housing part 3, with a web 38 connecting the disc 9 with the inner end area of the plunger 2. The web 38 runs through a longitudinal slot 37 that is located in the lower wall of the opening 36. Preferably, the web 38 and the disc 9 exhibit the shape of a one-part bent component.

One end of a helical compression spring 4 is supported at the disc 9. The other end of the compression spring 4 is supported at the housing part 3, advantageously at an end wall 28 of the same. In this manner, the plunger 2 is pressed outward due to the force of the compression spring 4 according to FIG. 4. It can be pressed against the force of the compression spring 4 through the door 12 into the housing part 18 in the position shown in FIG. 3, where the disc 9 is moved out of the area of the same in order to actuate the named magnetic switch 24.

It shall be noted that the present sensor arrangement can also be used for securing the interior of other receptacles or freight rooms. The sensor arrangement 1 is always installed such that it is attached to the receptacle itself using the magnetic device 6, 7 with the part holding the plunger 2 protruding in the direction of a door or a shutter or the like that can be moved toward the sensor arrangement 1 and in doing so actuates the plunger 2. Such a receptacle may be, for example, a freight room of a truck that can be locked through a loading platform that folds upward.

What is claimed is:

1. A sensor arrangement for securing the load of the interior of a container, comprising, in combination: a housing part; a magnetic device for attaching the housing part to a first door of the container; a sensor for monitoring the interior of the container; a first switch that is actuated when the housing part and the magnetic device is attached to the first door; a second switch that is actuated when a second door of the container is closed, said second door being located next to the first door; a microprocessor for evaluating alarm signals of the sensor; a power supply and a first transmitter; wherein the first switch switches on the power supply for activating the sensor arrangement when the housing part is attached to the first door; wherein the second switch activates the sensor for monitoring the interior when closing the second door; wherein the microprocessor processes the alarm signals generated by the sensor indicating an unauthorized entry into the interior and supplies the alarm signals to the first transmitter, which transmits them to a second transmitter located on the outside of the container for transmission to an intervention center.

2. A sensor arrangement as defined in claim 1, wherein the second transmitter includes a receiver which receives container position signals that are transmitted together with the alarm signals from the second transmitter to the intervention center.

3. A sensor arrangement as defined in claim 1, wherein the first door and the second door are pivoted in one plane for closing the container and are lockable using a locking mechanism; wherein the sensor arrangement is attached to the inner side of the first door using the magnetic device, and wherein a plunger that actuates the second switch protrudes beyond the edge area of the first door pointing towards the second door and is moveable to actuate the second switch when pivoting the second door.

4. A sensor arrangement as defined in claim 1, wherein the magnetic device comprises a first magnetic element and a second magnetic element that are located, respectively, at a distance from each other on the outside of the housing part and are attachable on the inner side of the first door.

5. A sensor arrangement as defined in claim 4, wherein magnetic elements in the assembled state of the sensor arrangement are oriented parallel to a rotational axis of the first door.

6. A sensor arrangement as defined in claim 1, wherein the first switch is a magnetic switch that can be actuated through a magnetically conducting material of the first door when attaching the sensor arrangement to the first door.

7. A sensor arrangement as defined in claim 3, wherein the second switch is a magnetic switch that is actuated through a magnetically conducting material part that moves with the plunger when the plunger is moved.

8. A sensor arrangement as defined in claim 7, wherein the plunger is movable against the force of a compression spring and comprises a disc, which actuates the magnetic switch when the plunger is actuated through the second door.

9. A sensor arrangement as defined in claim 1, wherein the sensor is an infrared sensor.

10. A sensor arrangement as defined in claim 1, wherein upon unauthorized opening of the first door before the second door, the sensor arrangement is separated from the first door by loosening the magnetic adhesion of the magnetic device, thereby actuating the first switch; and wherein the power supply is maintained by the microprocessor for a pre-specified period until a signal indicating the unauthorized opening of the first door has been transmitted via the transmitter to the intervention center.

11. A sensor arrangement as defined in claim 1, wherein the transmitter is a short distance radio transmitter.

12. A sensor arrangement as defined in claim 1, further comprising at least one other sensor for generating additional alarm signals when target values of a specified parameter are exceeded.

13. The sensor arrangement defined in claim 12, wherein the parameter is selected from the group consisting of temperature and humidity.
